(19) United States
(12) Patent Application Publication
(10) Pub. No.: US 2013/0261783 A1
(43) Pub. Date: Oct. 3, 2013

(54) METHOD FOR CREATING OF DYNAMIC PATIENT-SPECIFIC SURGICAL MONITORING SYSTEM

(71) Applicant: NAVIDENT TECHNOLOGIES, INC., North Vancouver (CA)

(72) Inventor: Ehud (Udi) Daon, North Vancouver (CA)

(73) Assignee: NAVIDENT TECHNOLOGIES, INC., North Vancouver (CA)

(21) Appl. No.: 13/745,249

(22) Filed: Jan. 18, 2013

Related U.S. Application Data
(60) Provisional application No. 61/616,698, filed on Mar. 28, 2012.

(51) Int. Cl. G06F 17/50

(52) U.S. Cl. CPC G06F 17/50
USPC 700/118; 29/592; 29/428; 29/896.1

(57) ABSTRACT

A method, system and software are presented for making a trackable mount for assisting with surgery within a surgical site, the trackable mount being trackable by a tracker disposed to obtain image information of the surgical site. A software model of the trackable mount is created based on scan data of the surgical site, and the making of the trackable mount is based on model data derived from the software model. The exterior shape of the trackable mount may incorporate a tracking marker, or tracking pole, or both. A system for executing the method consists of scan data of the surgical site, a controller with memory and processor, and a manufacturing device. In one embodiment the manufacturing device is a rapid prototyping machine. Software is presented for executing the method of the invention.

### CROSS REFERENCE TO RELATED APPLICATIONS

The present application claims priority under 35 U.S.C. §119(e) of U.S. Provisional Patent Application Ser. No. 61/616,698, filed on Mar. 28, 2012 and titled “Method for Creation of Dynamic Patient-Specific Surgical Monitoring System” the disclosure of which is expressly incorporated by reference herein.

### BACKGROUND OF THE INVENTION

1. Field of the Invention

The invention relates to location monitoring hardware and software systems. More specifically, the field of the invention is that of surgical equipment and software for monitoring surgical conditions.

2. Description of the Related Art

Visual and other sensory systems are known, with such systems being capable of both observing and monitoring surgical procedures. With such observation and monitoring systems, computer aided surgeries are now possible, and in fact are being routinely performed. In such procedures, the computer software interacts with both clinical images of the patient and observed surgical images from the current surgical procedure to provide guidance to the physician in conducting the surgery. For example, in one known system a carrier assembly bears at least one fiducial marker onto an attachment element in a precisely repeatable position with respect to a patient's jaw bone, employing the carrier assembly for providing registration between the fiducial marker and the patient's jaw bone and implanting the tooth implant by employing a tracking system which uses the registration to guide a drilling assembly. With this relatively new computer implemented technology, further improvements may further advance the effectiveness of surgical procedures.

### SUMMARY OF THE INVENTION

The present invention includes a method, system and software for dynamically creating an automatic patient tracking device specific to each patient without the need to take multiple X-ray or CT scans or to make patient specific casts. The automatic patient tracking device allows automatic surgical motion tracking in a regular clinical setting. The method may be used to reduce the time of admitting patient to a surgery significantly.

The system uses particularly configured software to create a mount that may be employed to attach a tracking marker to patient specific anatomy. For example, in the example of dental surgery the method, system and software of the present invention may be used to manufacture a tight fitting splint or mount to which may be attached a tracking marker that is tracked by the motion tracking system. The mount may serve as fiducial key or fiducial reference, or a fiducial key or reference may be attached to it, and the key may be used as the reference point for further image processing of the surgical site.

In one embodiment, the system constructs an industry standard computer file in a format that contains the instructions to create the specific trackable mount or key by a 3D milling machine, CNC machine or an STL printer/3D printer. Once the target machine receives the file it may be manufactured and be used as the coordinate system reference for the motion tracking system to follow the patient.

In one embodiment a trackable pole is attachable to the key and has a particular identifying pattern. The attachment and the pole itself have known configurations so that observational data from the pole may be precisely mapped to the coordinate system and thus the progress of the surgical procedure may be monitored and recorded. For example, the key may have a hole in a predetermined location specially adapted for engagement with the pole. In such an arrangement, for example, the poles may be attached with a low force push into the hole of the key, and an audible haptic notification may thus be given upon successful completion of the attachment.

The system of embodiments of the invention involves automatically computing the shape needed to generate the mount for the key. In the dental surgery example, the key has a base or mount that is mechanically fixated in patient mouth. The trackable mount may be used with one or more tracking poles that indicate to the tracker of the system where the patient is located. This provides, in the case of dental surgery, automatic recognition of the patient head location in space without the need to make models or splints.

In a first aspect of the invention there is presented a method for making a trackable mount for assisting with surgery within a surgical site, the trackable mount being trackable by a tracker disposed to obtain image information of the surgical site. The method comprises creating a software model of the trackable mount based on scan data of the surgical site and making the trackable mount based on model data derived from the software model. The exterior shape of the trackable mount may comprise at least one of the tracking pole and the tracking marker, thereby incorporating the at least one of the tracking pole and the tracking marker in the software model. The model data may be saved to a digital file. The method may comprise providing the model data to a manufacturing device. The manufacturing device may be a rapid prototyping apparatus and the making of the trackable mount may be the making of a rapid prototype of the trackable mount. Creating the software model may comprise obtaining the scan data of the surgical site; determining a suitable location for the trackable mount from the scan data; and establishing a model exterior shape for the trackable mount compatible with tracking of the trackable mount and with the location of the trackable mount.

In a second aspect of the invention there is presented a system for making a trackable mount for mounting proximate a surgical site, the mount trackable by a tracker disposed to obtain image information of the surgical site, the system comprising scan data of the surgical site, a controller comprising at least one processor and at least one memory, and a rapid prototyping apparatus. The controller is configured to create a software model of the trackable mount from the scan data and to extract model data from the software model. The rapid prototyping apparatus is configured for manufacturing the trackable mount based on the model data.

The system further comprises a set of executable instructions stored in memory and executable by a processor, the set of instructions comprising instructions for creating the software model based on the scan data, instructions for extracting the model data from the software model, and instructions for transferring the model data to the rapid prototyping apparatus. The instructions for creating the software model may comprise instructions for obtaining the scan data, determining a suitable location for the trackable mount from the scan data, and establishing a model exterior shape for the trackable mount compatible with tracking of the trackable mount and with the location of the trackable mount. In a further aspect of the invention there is provided.

In a further aspect of the present invention there is presented a non-transitory computer-readable storage medium encoding a first set of instructions executable by a controller, the first set of instructions comprising instructions for making a trackable mount for mounting proximate a surgical site, the mount trackable by a tracker disposed to obtain image information of the surgical site. The first set of instructions may comprise a second set of instructions for creating a software model of the trackable mount based on scan data of the surgical site, and a third set of instructions for making the trackable mount based on model data derived from the software model. The second set of instructions may comprise instructions for obtaining the scan data, determining a suitable location for the trackable mount from the scan data, and establishing a model exterior shape for the trackable mount compatible with tracking of the trackable mount and with the location of the trackable mount. The exterior shape of the trackable mount may comprise at least one of a tracking pole and a tracking marker disposed to be visible to the tracker. The third set of instructions may comprise instructions for transferring the model data to a manufacturing device.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic diagrammatic view of a network system in which embodiments of the present invention may be utilized.

FIG. 2 is a block diagram of a computing system (either a server or client, or both, as appropriate), with optional input devices (e.g., keyboard, mouse, touch screen, etc.) and output devices, hardware, network connections, one or more processors, and memory/storage for data and modules, etc. which may be utilized as controller and display in conjunction with embodiments of the present invention.

FIGS. 3A-J are drawings of hardware components of the surgical monitoring system according to embodiments of the invention.

FIGS. 4A and 4B are a flow chart diagrams illustrating a method for creating a trackable mount particularly configured for an individual patient.

FIG. 5 is a schematic diagram illustrating a system for creating a trackable mount particularly configured for an individual patient.

Corresponding reference characters indicate corresponding parts throughout the several views. Although the drawings represent embodiments of the present invention, the drawings are not necessarily to scale and certain features may be exaggerated in order to better illustrate and explain the present invention. The flow charts and screen shots are also representative in nature, and actual embodiments of the invention may include further features or steps not shown in the drawings. The exemplification set out herein illustrates an embodiment of the invention, in one form, and such exemplifications are not to be construed as limiting the scope of the invention in any manner.

### DESCRIPTION OF EMBODIMENTS OF THE PRESENT INVENTION

The embodiments disclosed below are not intended to be exhaustive or limit the invention to the precise form disclosed in the following detailed description. Rather, the embodiments are chosen and described so that others skilled in the art may utilize their teachings.

The detailed descriptions that follow are presented in part in terms of algorithms and symbolic representations of operations on data bits within a computer memory representing alphanumeric characters or other information. The hardware components are shown with particular shapes and relative orientations and sizes using particular scanning techniques, although in the general case one of ordinary skill recognizes that a variety of particular shapes and orientations and scanning methodologies may be used within the teaching of the present invention. A computer generally includes a processor for executing instructions and memory for storing instructions and data, including interfaces to obtain and process imaging data. When a general-purpose computer has a series of machine encoded instructions stored in its memory, the computer operating on such encoded instructions may become a specific type of machine, namely a computer particularly configured to perform the operations embodied by the series of instructions. Some of the instructions may be adapted to produce signals that control operation of other machines and thus may operate through those control signals to transform materials far removed from the computer itself. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities, observing and measuring scanned data representative of matter around the surgical site. Usually, though not necessarily, these quantities take the form of electrical or magnetic pulses or signals capable of being stored, transferred, transformed, combined, compared, and otherwise manipulated. It proves convenient at times, principally for reasons of common usage, to refer to these signals as bits, values, symbols, characters, display data, terms, numbers, or the like as a reference to the physical items or manifestations in which such signals are embodied or expressed to capture the underlying data of an image. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements that impart or manifest a physical organization on the information stored in memory. More than mere abstraction, the data structures are specific electrical or magnetic structural elements in memory, which simultaneously represent complex data accurately, often data modeling physical characteristics of related items, and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein that form part of the present invention; the operations are machine operations. Useful machines for performing the operations of the present invention include general-purpose digital computers or other similar devices. In all cases the distinction between the method operations in operating a computer and the method of computation itself should be recognized. The present invention relates to a method and apparatus for operating a computer in processing electrical or other (e.g., mechanical, chemical) physical signals to generate other desired physical manifestations or signals. The computer operates on software modules, which are collections of signals stored on a media that represents a series of machine instructions that enable the computer processor to perform the machine instructions that implement the algorithmic steps. Such machine instructions may be the actual computer code the processor interprets to implement the instructions, or alternatively may be a higher level coding of the instructions that is interpreted to obtain the actual computer code. The software module may also include a hardware component, wherein some aspects of the algorithm are performed by the circuitry itself rather as a result of an instruction.

The present invention also relates to an apparatus for performing these operations. This apparatus may be specifically constructed for the required purposes or it may comprise a general-purpose computer as selectively activated or reconfigured by a computer program stored in the computer. The algorithms presented herein are not inherently related to any particular computer or other apparatus unless explicitly indicated as requiring particular hardware. In some cases, the computer programs may communicate or relate to other programs or equipments through signals configured to particular protocols, which may or may not require specific hardware or programming to interact. In particular, various general-purpose machines may be used with programs written in accordance with the teachings herein, or it may prove more convenient to construct more specialized apparatus to perform the required method steps. The required structure for a variety of these machines will appear from the description below.

The present invention may deal with “object-oriented” software, and particularly with an “object-oriented” operating system. The “object-oriented” software is organized into “objects”, each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects. Often, but not necessarily, a physical object has a corresponding software object that may collect and transmit observed data from the physical device to the software system. Such observed data may be accessed from the physical object and/or the software object merely as an item of convenience; therefore where “actual data” is used in the following description, such “actual data” may be from the instrument itself or from the corresponding software object or module.

Messages are sent and received between objects having certain functions and knowledge to carry out processes. Messages are generated in response to user instructions, for example, by a user activating an icon with a “mouse” pointer generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system may be modeled with an object, the behavior of each component being simulated by the methods of its corresponding object, and the interactions between components being simulated by messages transmitted between objects.

An operator may stimulate a collection of interrelated objects comprising an object-oriented program by sending a message to one of the objects. The receipt of the message may cause the object to respond by carrying out predetermined functions, which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works through observation of the readily apparent manifestations of its operation. Most of the operations carried out by a computer in response to a program are “invisible” to an observer since only a relatively few steps in a program typically produce an observable computer output.

In the following description, several terms that are used frequently have specialized meanings in the present context. The term “object” relates to a set of computer instructions and associated data, which may be activated directly or indirectly by the user. The terms “windowing environment”, “running in windows”, and “object oriented operating system” are used to denote a computer user interface in which information is manipulated and displayed on a video display such as within bounded regions on a raster scanned video display. The terms “network”, “local area network”, “LAN”, “wide area network”, or “WAN” mean two or more computers that are connected in such a manner that messages may be transmitted between the computers. In such computer networks, typically one or more computers operate as a “server”, a computer with large storage devices such as hard disk drives and communication hardware to operate peripheral devices such as printers or moderns. Other computers, termed “workstations”, provide a user interface so that users of computer networks may access the network resources, such as shared data files, common peripheral devices, and inter-workstation communication. Users activate computer programs or network resources to create “processes” which include both the general operation of the computer program along with specific operating characteristics determined by input variables and its environment. Similar to a process is an agent (sometimes called an intelligent agent), which is a process that gathers information or performs some other service without user intervention and on some regular schedule. Typically, an agent, using parameters typically provided by the user, searches locations either on the host machine or at some other point on a network, gathers the information relevant to the purpose of the agent, and presents it to the user on a periodic basis.

The term “desktop” means a specific user interface which presents a menu or display of objects with associated settings for the user associated with the desktop. When the desktop accesses a network resource, which typically requires an application program to execute on the remote server, the desktop calls an Application Program Interface, or “API”, to allow the user to provide commands to the network resource and observe any output. The term “Browser” refers to a program which is not necessarily apparent to the user, but which is responsible for transmitting messages between the desktop and the network server and for displaying and interacting with the network user. Browsers are designed to utilize a communications protocol for transmission of text and graphic information over a worldwide network of computers, namely the “World Wide Web” or simply the “Web”. Examples of Browsers compatible with the present invention include the Internet Explorer program sold by Microsoft Corporation (Internet Explorer is a trademark of Microsoft Corporation), the Opera Browser program created by Opera Software ASA, or the Firefox browser program distributed by the Mozilla Foundation (Firefox is a registered trademark of the Mozilla Foundation). Although the following description details such operations in terms of a graphic user interface of a Browser, the present invention may be practiced with text based interfaces, or even with voice or visually activated interfaces, that have many of the functions of a graphic based Browser.

Browsers display information, which is formatted in a Standard Generalized Markup Language (“SGML”) or a HyperText Markup Language (“HTML”), both being scripting languages, which embed non-visual codes in a text document through the use of special ASCII text codes. Files in these formats may be easily transmitted across computer networks, including global information networks like the Internet, and allow the Browsers to display text, images, and play audio and video recordings. The Web utilizes these data file formats to conjunction with its communication protocol to transmit such information between servers and workstations. Browsers may also be programmed to display information provided in an eXtensible Markup Language (“XML”) file, with XML files being capable of use with several Document Type Definitions (“DTD”) and thus more general in nature than SGML or HTML. The XML file may be analogized to an object, as the data and the stylesheet formatting are separately contained (formatting may be thought of as methods of displaying information, thus an XML file has data and an associated method).

The terms “personal digital assistant” or “PDA”, as defined above, means any handheld, mobile device that combines computing, telephone, fax, e-mail and networking features. The terms “wireless wide area network” or “WWAN” mean a wireless network that serves as the medium for the transmission of data between a handheld device and a computer. The term “synchronization” means the exchanging of information between a first device, e.g. a handheld device, and a second device, e.g. a desktop computer, either via wires or wirelessly. Synchronization ensures that the data on both devices are identical (at least at the time of synchronization).

In wireless wide area networks, communication primarily occurs through the transmission of radio signals over analog, digital cellular, or personal communications service (“PCS”) networks. Signals may also be transmitted through microwaves and other electromagnetic waves. At the present time, most wireless data communication takes place across cellular systems using second generation technology such as code-division multiple access (“CDMA”), time division multiple access (“TDMA”), the Global System for Mobile Communications (“GSM”), Third Generation (wideband or “3G”), Fourth Generation (broadband or “4G”), personal digital cellular (“PDC”), or through packet-data technology over analog systems such as cellular digital packet data (CDPD”) used on the Advance Mobile Phone Service (“AMPS”).

The terms “wireless application protocol” or “WAP” mean a universal specification to facilitate the delivery and presentation of web-based data on handheld and mobile devices with small user interfaces. “Mobile Software” refers to the software operating system, which allows for application programs to be implemented on a mobile device such as a mobile telephone or PDA. Examples of Mobile Software are Java and Java ME (Java and JavaME are trademarks of Sun Microsystems, Inc. of Santa Clara, Calif.), BREW (BREW is a registered trademark of Qualcomm Incorporated of San Diego, Calif.), Windows Mobile (Windows is a registered trademark of Microsoft Corporation of Redmond, Wash.), Palm OS (Palm is a registered trademark of Palm, Inc. of Sunnyvale, Calif.), Symbian OS (Symbian is a registered trademark of Symbian Software Limited Corporation of London, United Kingdom), ANDROID OS (ANDROID is a registered trademark of Google, Inc. of Mountain View, Calif.), and iPhone OS (iPhone is a registered trademark of Apple, Inc. of Cupertino, Calif.) and Windows Phone 7. “Mobile Apps” refers to software programs written for execution with Mobile Software.

The terms “scan,” “fiducial reference”, “fiducial location”, “marker,” “tracker” and “image information” have particular meanings in the present disclosure. For purposes of the present disclosure, “scan” or derivatives thereof refer to x-ray, magnetic resonance imaging (MRI), computerized tomography (CT), sonography, cone beam computerized tomography (CBCT), or any system that produces a quantitative spatial representation of a patient. The term “fiducial reference” or simply “fiducial” refers to an object or reference on the image of a scan that is uniquely identifiable as a fixed recognizable point. In the present specification the term “fiducial location” refers to a useful location to which a fiducial reference is attached. A “fiducial location” will typically be proximate a surgical site. The term “marker” or “tracking marker” refers to an object or reference that may be perceived by a sensor proximate to the location of the surgical or dental procedure, where the sensor may be an optical sensor, a radio frequency identifier (RFID), a sonic motion detector, an ultra-violet or infrared sensor. The term “tracker” refers to a device or system of devices able to determine the location of the markers and their orientation and movement continually in ‘real time’ during a procedure. As an example of a possible implementation, if the markers are composed of printed targets then the tracker may include a stereo camera pair. The term “image information” is used in the present specification to describe information obtained by the tracker, whether optical or otherwise, and usable for determining the location of the markers and their orientation and movement continually in ‘real time’ during a procedure.

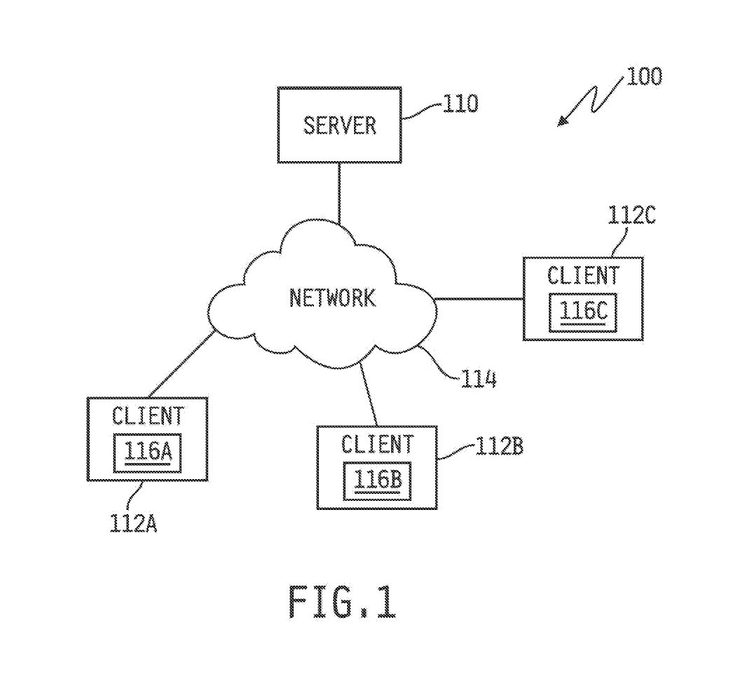

FIG. 1 is a high-level block diagram of a computing environment 100 according to one embodiment. FIG. 1 illustrates server 110 and three clients 112 connected by network 114. Only three clients 112 are shown in FIG. 1 in order to simplify and clarify the description. Embodiments of the computing environment 100 may have thousands or millions of clients 112 connected to network 114, for example the Internet. Users (not shown) may operate software 116 on one of clients 112 to both send and receive messages network 114 via server 110 and its associated communications equipment and software (not shown).

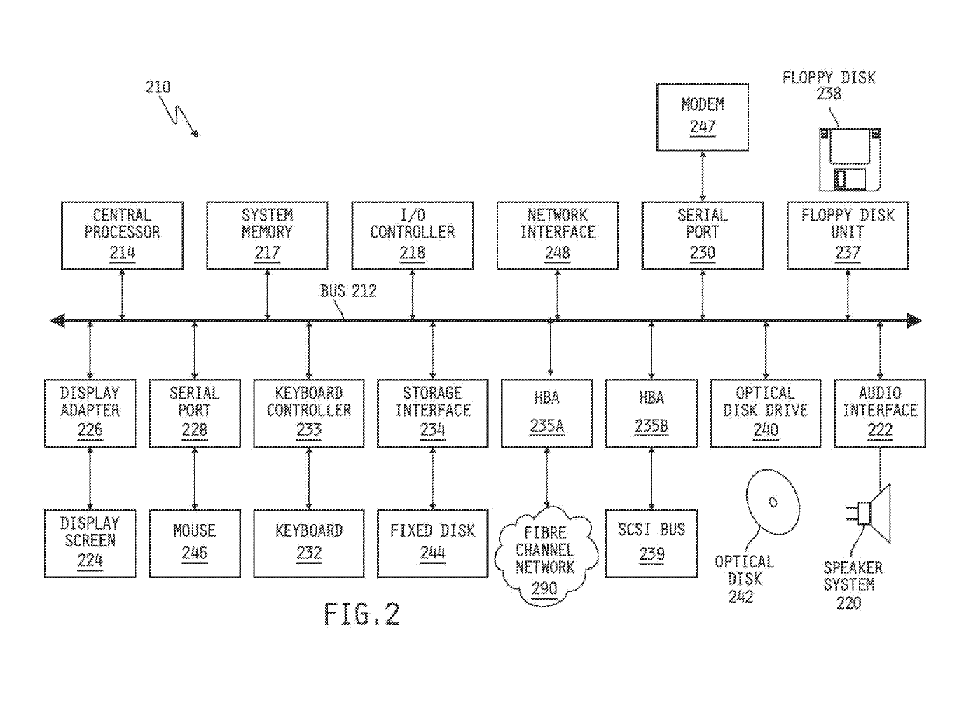

FIG. 2 depicts a block diagram of computer system 210 suitable for implementing server 110 or client 112. Computer system 210 includes bus 212 which interconnects major subsystems of computer system 210, such as central processor 214, system memory 217 (typically RAM, but which may also include ROM, flash RAM, or the like), input/output controller 218, external audio device, such as speaker system 220 via audio output interface 222, external device, such as display screen 224 via display adapter 226, serial ports 228 and 230, keyboard 232 (interfaced with keyboard controller 233), storage interface 234, disk drive 237 operative to receive floppy disk 238, host bus adapter (HBA) interface card 235A operative to connect with Fibre Channel network 290, host bus adapter (HBA) interface card 235B operative to connect to SCSI bus 239, and optical disk drive 240 operative to receive optical disk 242. Also included are mouse 246 (or other point-and-click device, coupled to bus 212 via serial port 228), modem 247 (coupled to bus 212 via serial port 230), and network interface 248 (coupled directly to bus 212).

Bus 212 allows data communication between central processor 214 and system memory 217, which may include read-only memory (ROM) or flash memory (neither shown), and random access memory (RAM) (not shown), as previously noted. RAM is generally the main memory into which operating system and application programs are loaded. ROM or flash memory may contain, among other software code, Basic Input-Output system (BIOS), which controls basic hardware operation such as interaction with peripheral components. Applications resident with computer system 210 are generally stored on and accessed via computer readable media, such as hard disk drives (e.g., fixed disk 244), optical drives (e.g., optical drive 240), floppy disk unit 237, or other storage medium. Additionally, applications may be in the form of electronic signals modulated in accordance with the application and data communication technology when accessed via network modem 247 or interface 248 or other telecommunications equipment (not shown).

Storage interface 234, as with other storage interfaces of computer system 210, may connect to standard computer readable media for storage and/or retrieval of information, such as fixed disk drive 244. Fixed disk drive 244 may be part of computer system 210 or may be separate and accessed through other interface systems. Modem 247 may provide direct connection to remote servers via telephone link or the Internet via an Internet service provider (ISP) (not shown). Network interface 248 may provide direct connection to remote servers via direct network link to the Internet via a POP (point of presence). Network interface 248 may provide such connection using wireless techniques, including digital cellular telephone connection, Cellular Digital Packet Data (CDPD) connection, digital satellite data connection or the like.

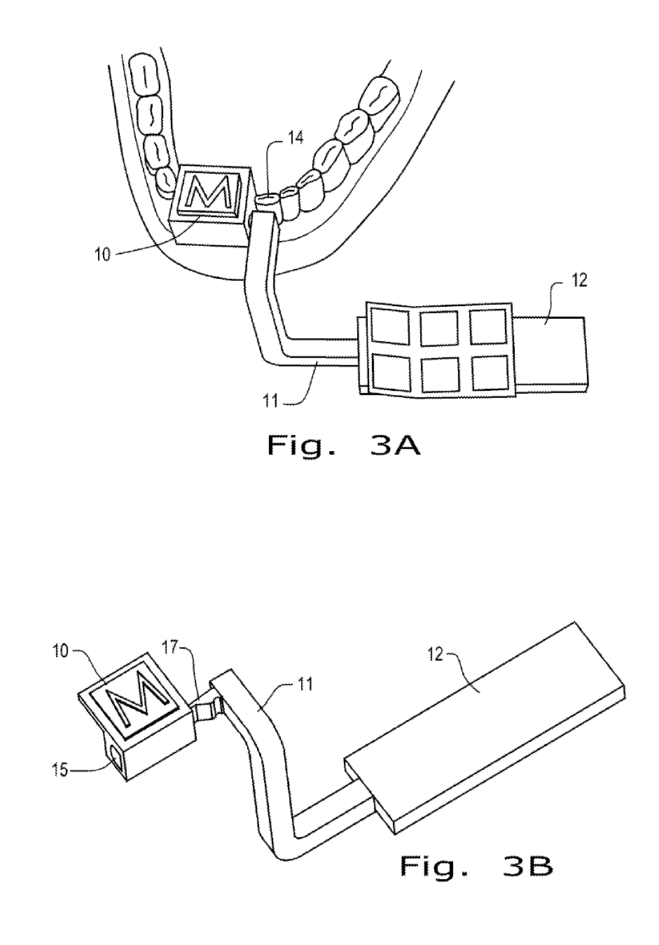

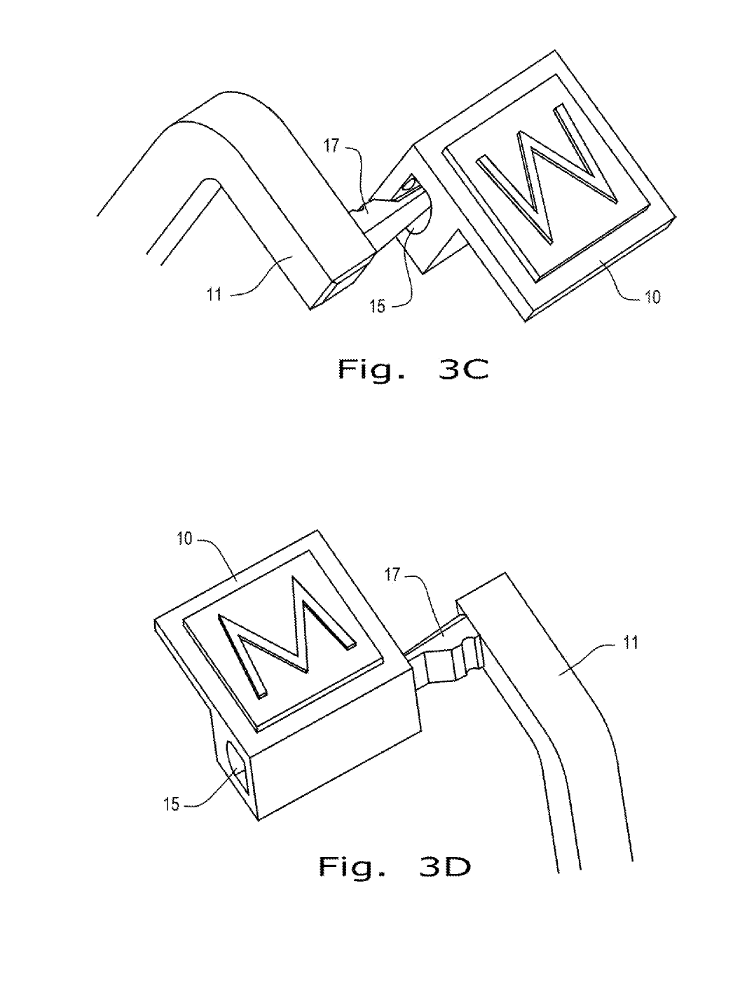

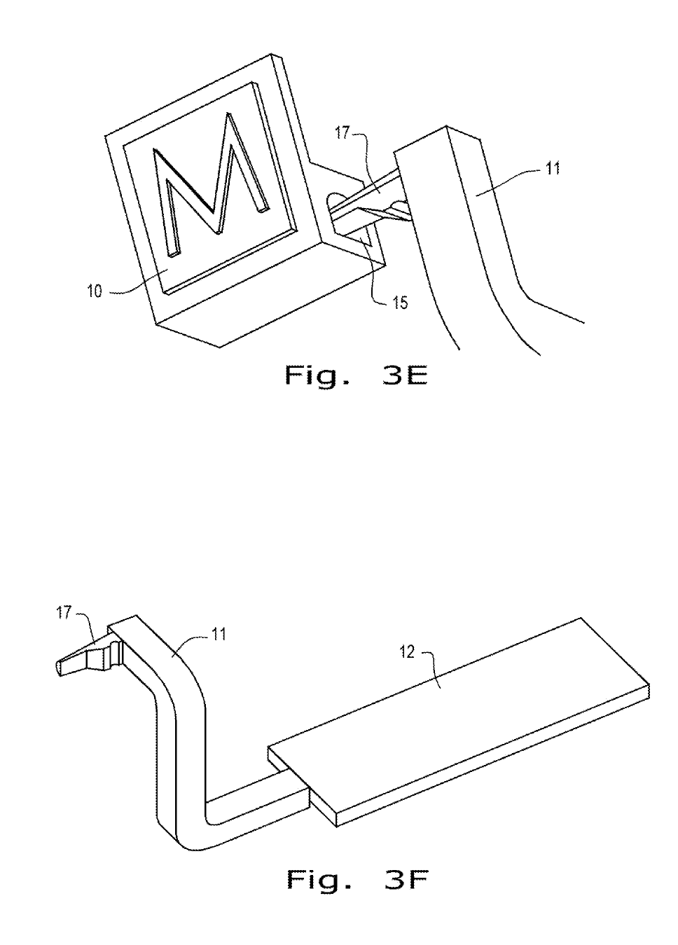

Many other devices or subsystems (not shown) may be connected in a similar manner (e.g., document scanners, digital cameras and so on), including the hardware components of FIGS. 3A-I, which alternatively may be in communication with associated computational resources through local, wide-area, or wireless networks or communications systems. Thus, while the disclosure may generally discuss an embodiment where the hardware components are directly connected to computing resources, one of ordinary skill in this area recognizes that such hardware may be remotely connected with computing resources. Conversely, all of the devices shown in FIG. 2 need not be present to practice the present disclosure. Devices and subsystems may be interconnected in different ways from that shown in FIG. 2. Operation of a computer system such as that shown in FIG. 2 is readily known in the art and is not discussed in detail in this application. Software source and/or object codes to implement the present disclosure may be stored in computer-readable storage media such as one or more of system memory 217, fixed disk 244, optical disk 242, or floppy disk 238. The operating system provided on computer system 210 may be a variety or version of either MS-DOS® (MS-DOS is a registered trademark of Microsoft Corporation of Redmond, Washington), WINDOWS® (WINDOWS is a registered trademark of Microsoft Corporation of Redmond, Wash.), OS/2® (OS/2 is a registered trademark of International Business Machines Corporation of Armonk, N.Y.), UNIX® (UNIX is a registered trademark of X/Open Company Limited of Reading, United Kingdom), Linux® (Linux is a registered trademark of Linus Torvalds of Portland, Oreg.), or other known or developed operating system.

Moreover, regarding the signals described herein, those skilled in the art recognize that a signal may be directly transmitted from a first block to a second block, or a signal may be modified (e.g., amplified, attenuated, delayed, latched, buffered, inverted, filtered, or otherwise modified) between blocks. Although the signals of the above-described embodiments are characterized as transmitted from one block to the next, other embodiments of the present disclosure may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

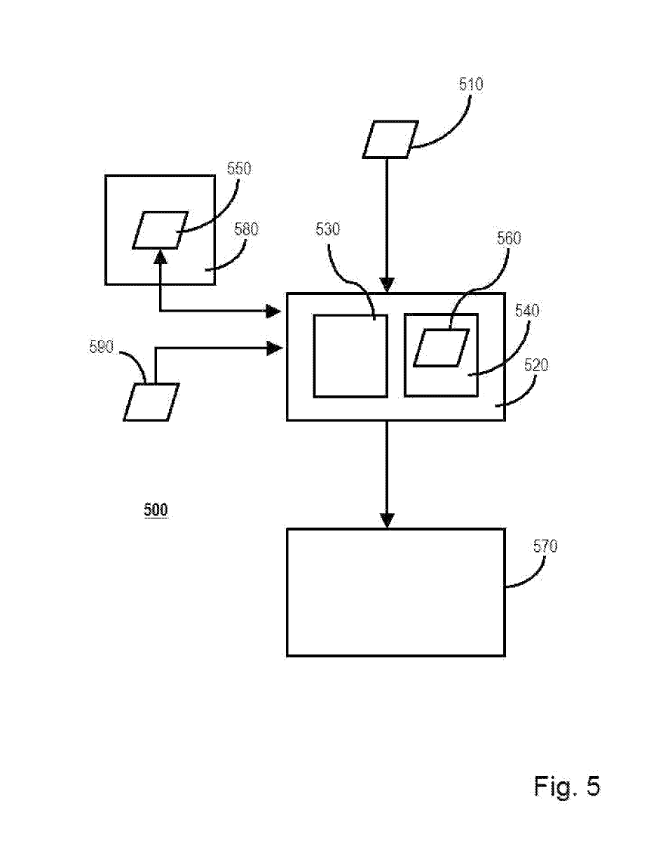

The present invention relates to a surgical hardware and software monitoring system and method which allows for surgical planning while the patient is available for surgery, for example while the patient is being prepared for surgery so that the system may model the surgical site. The system uses a particularly configured piece of hardware, represented as fiducial key 10 in FIG. 3A, to orient tracking marker 12 of the monitoring system with regard to the critical area of the surgery. Fiducial key 10 is attached to a location near the intended surgical area, in the exemplary embodiment of the dental surgical area of FIG. 3A, fiducial key 10 is attached to a dental splint 14. Tracking marker 12 may be connected to fiducial key 10 by tracking pole 11. In embodiments in which the fiducial reference is directly visible to a suitable tracker (see for example FIG. 5 and FIG. 6) that acquires image information about the surgical site, a tracking marker may be attached directly to the fiducial reference. For example a dental surgery, the dental tracking marker 14 may be used to securely locate the fiducial 10 near the surgical area. The fiducial key 10 may be used as a point of reference, or a fiducial, for the further image processing of data acquired from tracking marker 12 by the tracker.

In other embodiments additional tracking markers 12 may be attached to items independent of the fiducial key 10 and any of its associated tracking poles 11 or tracking markers 12. This allows the independent items to be tracked by the tracker.

In a further embodiment at least one of the items or instruments near the surgical site may optionally have a tracker attached to function as tracker for the monitoring system of the invention and to thereby sense the orientation and the position of the tracking marker 12 and of any other additional tracking markers relative to the scan data of the surgical area. By way of example, the tracker attached to an instrument may be a miniature digital camera and it may be attached, for example, to a dentist's drill. Any other markers to be tracked by the tracker attached to the item or instrument must be within the field of view of the tracker.

In co-pending patent applications PCT International Application Serial No. PCT/IL2012/000363 (designating the United States) and U.S. patent application Ser. No. 13/571,284, both expressly incorporated by reference herein, a surgical hardware and software monitoring system and associated method of use are described employing the fiducial key 10 and its associated tracking poles 11 and and tracking markers 12.

Using the dental surgery example, the patient is scanned to obtain an initial scan of the surgical site. The particular configuration of fiducial key 10 allows computer software stored in memory and executed in a suitable controller, for example processor 214 and memory 217 of computer 210 of FIG. 2, to recognize its relative position within the surgical site from the scan data, so that further observations may be made with reference to both the location and orientation of fiducial key 10. In some embodiments, the fiducial reference includes a marking that is apparent as a recognizable identifying symbol when scanned. In other embodiments, the fiducial reference includes a shape that is distinct in the sense that the body apparent on the scan has an asymmetrical form allowing the front, rear, upper, and lower, and left/right defined surfaces that may be unambiguously determined from the analysis of the scan, thereby to allow the determination not only of the location of the fiducial reference, but also of its orientation.

In addition, the computer software may create a coordinate system for organizing objects in the scan, such as teeth, jaw bone, skin and gum tissue, other surgical instruments, etc. The coordinate system relates the images on the scan to the space around the fiducial and locates the instruments bearing markers both by orientation and position. The model generated by the monitoring system may then be used to check boundary conditions, and in conjunction with the tracker display the arrangement in real time on a suitable display, for example display 224 of FIG. 2.

In one embodiment, disclosed in the aforementioned applications PCT PCT/IL2012/000363 and U.S. Ser. No. 13/571,284, the computer system has a predetermined knowledge of the physical configuration of fiducial key 10 and examines slices/sections of the scan to locate fiducial key 10. Locating of fiducial key 10 may be on the basis of its distinct shape, or on the basis of distinctive identifying and orienting markings upon the fiducial key or on attachments to the fiducial key 10 as tracking marker 12. Fiducial key 10 may be rendered distinctly visible in the scans through higher imaging contrast by the employ of radio-opaque materials or high-density materials in the construction of the fiducial key 10. In other embodiments the material of the distinctive identifying and orienting markings may be created using suitable high density or radio-opaque inks or materials.

Once fiducial key 10 is identified, the location and orientation of the fiducial key 10 is determined from the scan segments, and a point within fiducial key 10 is assigned as the center of the coordinate system. The point so chosen may be chosen arbitrarily, or the choice may be based on some useful criterion. A model is then derived in the form of a transformation matrix to relate the fiducial system, being fiducial key 10 in one particular embodiment, to the coordinate system of the surgical site. The resulting virtual construct may be used by surgical procedure planning software for virtual modeling of the contemplated procedure, and may alternatively be used by instrumentation software for the configuration of the instrument, for providing imaging assistance for surgical software, and/or for plotting trajectories for the conduct of the surgical procedure.

In some embodiments, the monitoring hardware includes a tracking attachment to the fiducial reference. In the embodiment pertaining to dental surgery the tracking attachment to fiducial key 10 is tracking marker 12, which is attached to fiducial key 10 via tracking pole 11. Tracking marker 12 may have a particular identifying pattern. The trackable attachment, for example tracking marker 12, and even associated tracking pole 11 may have known configurations so that observational data from tracking pole 11 and/or tracking marker 12 may be precisely mapped to the coordinate system, and thus progress of the surgical procedure may be monitored and recorded. For example, as particularly shown in FIG. 3J, fiducial key 10 may have hole 15 in a predetermined location specially adapted for engagement with insert 17 of tracking pole 11. In such an arrangement, for example, tracking poles 11 may be attached with a low force push into hole 15 of fiducial key 10, and an audible haptic notification may thus be given upon successful completion of the attachment.

It is further possible to reorient the tracking pole during a surgical procedure. Such reorientation may be in order to change the location of the procedure, for example where a dental surgery deals with teeth on the opposite side of the mouth, where a surgeon switches hands, and/or where a second surgeon performs a portion of the procedure. For example, the movement of the tracking pole may trigger a re-registration of the tracking pole with relation to the coordinate system, so that the locations may be accordingly adjusted. Such a re-registration may be automatically initiated when, for example in the case of the dental surgery embodiment, tracking pole 11 with its attached tracking marker 12 are removed from hole 15 of fiducial key 10 and another tracking marker with its associated tracking pole is connected to an alternative hole on fiducial key 10. Additionally, boundary conditions may be implemented in the software so that the user is notified when observational data approaches and/or enters the boundary areas.

In a further embodiment of the system utilizing the invention, a surgical instrument or implement, herein termed a “hand piece”, may also have a particular configuration that may be located and tracked in the coordinate system and may have suitable tracking markers as described herein. A boundary condition may be set up to indicate a potential collision with virtual material, so that when the hand piece is sensed to approach the boundary condition an indication may appear on a screen, or an alarm sound. Further, target boundary conditions may be set up to indicate the desired surgical area, so that when the trajectory of the hand piece is trending outside the target area an indication may appear on screen or an alarm sound indicating that the hand piece is deviating from its desired path.

An alternative embodiment of some hardware components are shown in FIGS. 3G-I. Fiducial key 10′ has connection elements with suitable connecting portions to allow a tracking pole 11′ to position a tracking marker 12′ relative to the surgical site. Conceptually, fiducial key 10′ serves as an anchor for pole 11′ and tracking marker 12′ in much the same way as the earlier embodiment, although it has a distinct shape. The software of the monitoring system is pre-programmed with the configuration of each particularly identified fiducial key, tracking pole, and tracking marker, so that the location calculations are only changed according to the changed configuration parameters.

The materials of the hardware components may vary according to regulatory requirements and practical considerations. In the case of the embodiments described in the aforementioned applications PCT PCT/IL2012/000363 and U.S. Ser. No. 13/571,284, the key or fiducial component 10, 10′ may be made of generally radio opaque material such that it does not produce noise for the scan, yet creates recognizable contrast on the scanned image so that any identifying pattern associated with it may be recognized. In addition, because it is generally located on the patient, the material should be lightweight and suitable for connection to an apparatus on the patient. For example, in the dental surgery example, the materials of the fiducial key 10, 10′ must be suitable for connection to a plastic splint and suitable for connection to a tracking pole. In the surgical example the materials of the fiducial key 10, 10′ may be suitable for attachment to the skin or other particular tissue of a patient.

The tracking markers 12, 12′ are clearly identified by employing, for example without limitation, high contrast pattern engraving. The materials of the tracking markers 12, 12′ are chosen to be capable of resisting damage in autoclave processes and are compatible with rigid, repeatable, and quick connection to a connector structure. The tracking markers 12, 12′ and associated tracking poles 11, 11′ have the ability to be accommodated at different locations for different surgery locations, and, like the fiducial keys 10, 10′, they should also be relatively lightweight as they will often be resting on or against the patient. The tracking poles 11, 11′ must similarly be compatible with autoclave processes and have connectors of a form shared among tracking poles 11, 11′.

The tracker employed in tracking the fiducial keys 10, 10′, tracking poles 11, 11′ and tracking markers 12, 12′ should be capable of tracking with suitable accuracy objects of a size of the order of 1.5 square centimeters. The tracker may be, by way of example without limitation, a stereo camera or stereo camera pair. While the tracker is generally connected by wire to a computing device to read the sensory input, it may optionally have wireless connectivity to transmit the sensory data to a computing device.

In embodiments that additionally employ a trackable piece of instrumentation, such as a hand piece, tracking markers attached to such a trackable piece of instrumentation may also be light-weight; capable of operating in a 3 object array with 90 degrees relationship; optionally having a high contrast pattern engraving and a rigid, quick mounting mechanism to a standard hand piece.

Having described those implementations in which a fiducial reference is required in the scans of the surgical site, we now turn to further embodiments in which the tracking may be performed using the same arrangement as already described heretofore, with the distinction that no key or fiducial component needs to be detected in the scan of the surgical area. Instead, use is made of a natural fiducial that is evident in the scan. For example, in the case of dental surgery, a particular tooth, such as a canine, may be used as natural fiducial, thereby removing the need for the radio-opaque fiducial key. In co-pending patent application Ser. No. 13/744,967, filed on Jan. 18, 2013, entitled “SURGICAL LOCATION MONITORING SYSTEM AND METHOD USING NATURAL MARKERS,” and its provisional application Ser. No. 61/723,993 of the same title, the disclosures of which are incorporated by reference herein, the use of a natural fiducial within a surgical monitoring system is described. However, the need for a trackable mount to the natural fiducial may remain in some surgical cases, as may the need for a separate tracking marker 12 and, in some cases, for a trackable pole 11. In particular, we consider the matter of the making of a trackable mount for such implementations.

In one aspect of the present invention there is provided a method for making a patient-specific trackable mount for assisting with surgery within a surgical site, the trackable mount being particularly configured for an individual surgical site and trackable by a tracker disposed to obtain an image information of the surgical site. The term “trackable mount” is used in the present specification to describe a mechanical component that may be attached to or mounted at a selected anatomical point proximate or within a surgical site and to which other components may be attached or mounted. The trackable mount may be configured for use with one or more of trackable markers 12 and 12′ of the aforegoing embodiments, as well as with tracking poles 11 and 11′ of the same aforegoing embodiments. The trackable marker 12, 12′ or tracking pole 11, 11′, or both, may be part of the trackable mount and thereby part of its exterior shape.

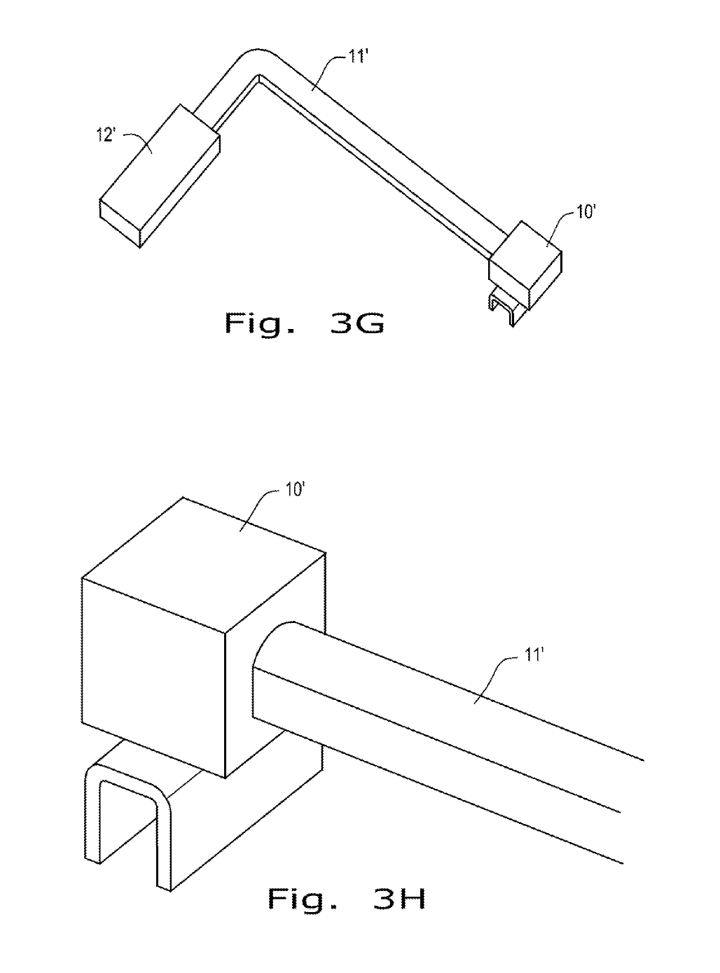

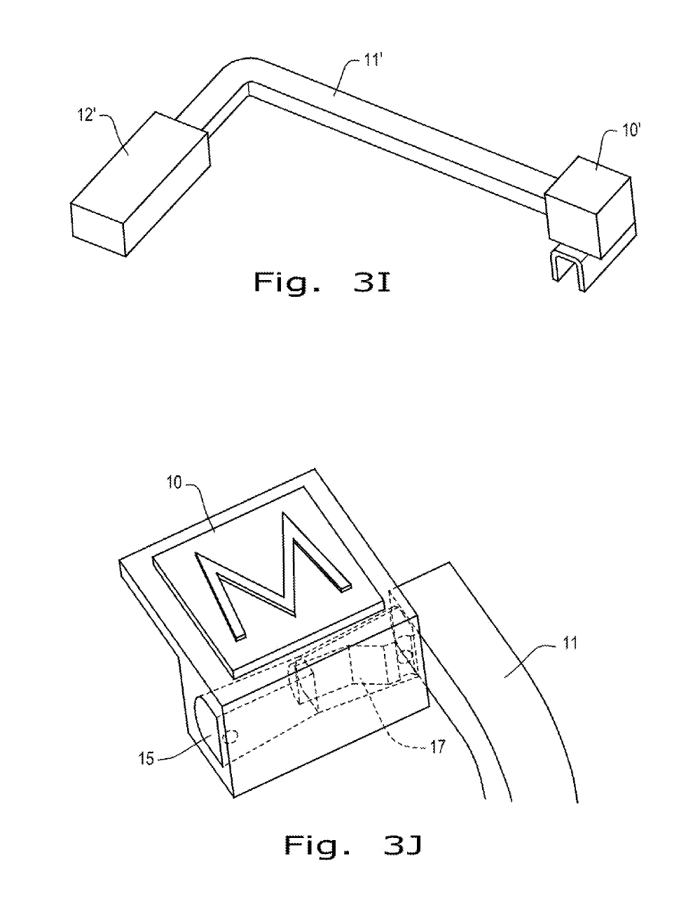

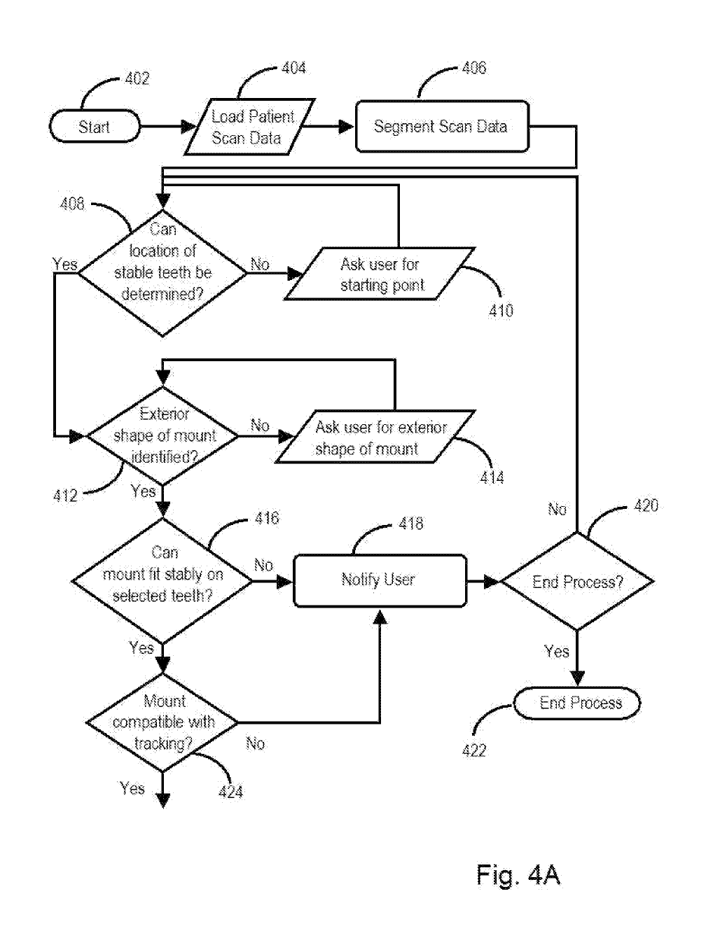

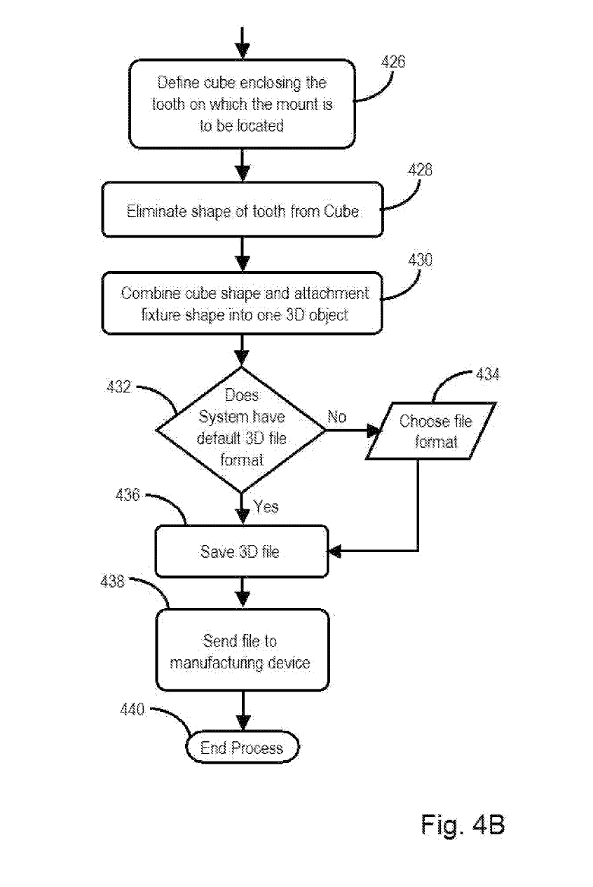

FIGS. 4A and 4B show the operation of one embodiment of a method and associated software for creating a patient-specific trackable mount for tracking by a surgical monitoring device as applied to dental surgery. The process starts [402] by obtaining scan data of the patient surgery site, for example by loading an available patient CT scan [404]. The scan data is then segmented [406], optionally using three dimensions. This allows computer software stored in memory and executed in a suitable controller, for example processor 214 and memory 219 of computer 210 of FIG. 2, to analyze the scan data to determine a suitable location for the trackable mount. For example, in the case of dental surgery, the location of a stable tooth may be such a location and the software may scan for that location [408]. In alternative embodiments, for example for arm surgery, the location of a point on the humerus may be such a location, or with knee surgery the location of the femur may be the location for which the software scans. If the software does not automatically determine a suitable mounting point, then the user may be prompted to designate a start location for that determination [410]. The software determines whether an exterior shape has been identified for the mount [412]. If an exterior shape has not been identified for the mount, then a suitable exterior shape for the mount is requested from the user [414] and the process returns to determining whether an exterior shape has been identified for the mount [412].

If an exterior shape for the mount has been identified [at 412], then the software determines whether the trackable mount with the identified exterior shape may stably fit on the selected location. For example, in the case of dental surgery this may comprise testing whether a patient-specific trackable mount of identified shape may be stably mounted on the selected tooth [416]. If the mount cannot stably fit on the selected location, then the user is notified [418], and the software checks [420] with the user whether the process is to be ended [422], or whether it should proceed. If the process is not to be terminated, the location selection [408] is restarted.

If the trackable mount with the identified exterior shape may be mounted stably to the desired location [at 416], then the shape of the trackable mount is checked for whether it is compatible with tracking [424]. For example, it may be checked for whether it allows a suitable tracking marker to be attached reproducibly as regards location and orientation. The suitable tracking marker, for example tracking marker 12 of FIG. 3A, may be attached directly to the mount or may be attached to the mount using a suitable tracking pole; for example tracking pole 11 of FIG. 3A. Checking for whether the tracking marker fits reproducibly as regards location and orientation may specifically include checking that a tracking marker attached via a tracking pole will have a useful location and orientation. This may be done to ensure that the tracking marker has a location and orientation that render it visible to a suitable tracker. By way of example, in the case of dental surgery the trackable mount may be checked as to whether it allows a pole to be attached with a tracking marker that will be visible to a camera that serves as tracker. Other alternative examples similarly involve the observability of the tracking marker by the radiographic device used by the surgical monitoring system.

If the mount is not compatible with tracking [at 424], then the user is notified [418] so that the decision may be made [420] whether to restart the location selection [at 408] or end the process [at 422].

If the mount is compatible with tracking [at 424], then the software creates a model of a mount that includes the desired external shape and which is adapted to hold a tracking marker for a motion tracking system to monitor patient movement during surgery. In the dental surgery example, this may be accomplished by defining a cube [at 426] enclosing the tooth upon which the mount is to be located. The system software then proceeds to generate a manufacturing program executable by a manufacturing device so that the manufacturing device manufactures an article according to the model. This may be accomplished, for example, by creating a part program for a Computer Numerical Controlled (CNC) machine tool or creating a Computer Aided Design (CAD) rendered to a Standard Tessellation Language (STL), Additive Manufacturing File (AMF), or other open source or proprietary file format defining the shape of an article to be created with a three dimensional printer. Various technologies for producing an article according to such a model include, without being limited to, extrusion (e.g., Fused Deposition Modeling or FDM), granular (e.g., Direct Metal Laser Sintering or DMLS, Electron Beam Melting or EBM, selective heat sintering or SHS, selective laser sintering or SLS, Powder bed and inkjet head 3D printing, Plaster-based 3D Printing or PP), laminated (e.g., Laminated Object Manufacturing or LOM), and Light Polymerized (e.g., Stereolithography or SLA, Digital Light Processing or DLP) technologies.

Returning to the dental surgery example, the cube defined between the key and tooth is modeled by removing the three dimensional contours of the tooth from the cube [428] and adding the shape of any attachment fixture to be used for attaching a tracking marker, a tracking pole in order to make the model of the mount [430]. The software checks for whether the system has a default file format [at 432]. If the answer is in the affirmative, the model is saved in the default three-dimensional file format [436]. If the answer is in the negative, then a file format is chosen [434] and the model is saved in that three-dimensional file format [at 436]. The model is thereby saved into an appropriate three-dimensional file format using either a default or user chosen file format.

To physically fashion the trackable mount, the software may be provided to a manufacturing device [at 438], such as a three-dimensional printing device, a CNC machine tool, or any other appropriate rapid prototyping machine. The process is then ended [at 440].

The manufacturing device may optionally be a remote machine wherein the saved file is electronically transmitted, for example, by e-mail or file transfer protocol (FTP) over a network such as the Internet. In a further alternative, after the selection of a destination machine the system may store the saved file with the three dimensional manufacturing pattern to a computer readable media to be loaded into an appropriate manufacturing machine at a later time.

This method of one embodiment of the invention may also be described in a hierarchical structure in which the method comprises creating a software model of the trackable mount based on the scan data of the surgical site and making the trackable mount based on model data derived from the software model, in one embodiment the software model being a mathematical definition of the shape and contour of the trackable mount, and the model data being the manufacturing information needed by the manufacturing device to create an article matching the shape and contour of the software model. Creating the software model may comprise obtaining the scan data of the surgical site, determining a suitable location for the trackable mount from the scan data, and establishing a model exterior shape for the trackable mount compatible with tracking of the trackable mount and compatible with the location of the trackable mount. Establishing the model exterior shape of the trackable mount may comprise confirming that the model exterior shape allows the trackable mount to be usefully trackable by the tracker and confirming that the model exterior shape allows the trackable mount to be stably mountable at the location. Confirming that the model exterior shape allows the trackable mount to be usefully trackable may comprise confirming that the model exterior shape is configured and arranged for the attaching of a tracking marker disposed to be visible to the tracker. The attaching of the tracking marker disposed to be visible to the tracker may comprise attaching a tracking pole to the trackable mount and attaching the tracking marker to the tracking pole. The exterior shape of the trackable mount may comprise at least one of the tracking pole and the tracking marker, thereby incorporating the at least one of the tracking pole and the tracking marker in the software model.

Confirming that the model exterior shape allows the trackable mount to be stably mountable at the location may comprise confirming that the model exterior shape allows the trackable mount to be reproducibly mountable at the location. The establishing the model exterior shape of the trackable mount may comprise searching a database for a predetermined exterior shape.

The surgical site may be a dental site. The suitable location may be a suitable anchor tooth proximate the surgical site. The model exterior shape of the trackable mount may be a mathematically describable three-dimensional shape enclosing the anchor tooth. The mathematically describable three-dimensional shape may be at least one of a cube, a cuboid, a prismatoid, a parallelepiped and a cylinder. The method may further comprise removing the three dimensional contours of the tooth from the mathematically describable three-dimensional shape enclosing the anchor tooth.

The method may further comprise adding to the model exterior shape for the trackable mount the shape of any attachment fixture to be used for attaching any one or more of a tracking marker, and a tracking pole. The making of the trackable mount may include making a rapid prototype of the trackable mount. The method may comprise providing the model data to a manufacturing device. The manufacturing device may be a rapid prototyping device.

The creating of a software model may comprise extracting the model data from the software model and saving the model data to a digital file, the digital file having a three-dimensional digital file format. Saving the model data to a digital file may comprise saving the digital file to a non-transitory computer-readable storage medium readable by a controller, for example computer 210 of FIG. 2.

In a further aspect of the present invention there is presented a system, shown generally at 500 in FIG. 5. System 500 is configured for making a trackable mount for mounting proximate a surgical site, the mount trackable by a tracker disposed to obtain image information of the surgical site. System 500 has access to scan data 510 of the surgical site and comprises controller 520 comprising at least one processor 530 and at least one memory 540, controller 520 configured for obtaining model data 550 from a software model of the trackable mount. System 500 may further comprise a first set 560 of executable instructions stored in the at least one memory 540 and executable by the at least one processor 530, first set of executable instructions 560 comprising second set of instructions for creating the software model based on the scan data 510 and a third set of instructions for extracting the model data from the software model. System 500 may further comprise manufacturing device 570 configured for manufacturing the trackable mount based on the model data. First set of executable instructions 560 may further comprise a fourth set of instructions for transferring model data 550 to manufacturing device 570. Manufacturing device 570 may be a rapid prototyping apparatus. First set of executable instructions 560 may further comprise a fifth set of instructions for transferring model data 550 to non-transitory computer-readable storage medium 580 readable by controller 520.

Second set of instructions may comprise instructions for obtaining scan data 510, instructions for determining a suitable location for the trackable mount from scan data 510, and instructions for establishing a model exterior shape for the trackable mount compatible with tracking of the trackable mount and with the location of the trackable mount. The exterior shape of the trackable mount may comprise tracking pole 11, 11′ or tracking marker 12, 12′ or both, both disposed to be visible to the tracker, as per the aforegoing embodiments in FIGS. 3A to 3J. The establishing of the model exterior shape of the trackable mount may comprise confirming that the model exterior shape allows the trackable mount to be usefully trackable by the tracker, and confirming that the model exterior shape allows the trackable mount to be stably mountable at the location. Confirming that the model exterior shape allows the trackable mount to be usefully trackable may comprise confirming that the model exterior shape is configured for the attaching of tracking marker 12, 12′ disposed to be visible to the tracker. Attaching of a tracking marker, for example tracking marker 12, 12′ as per the aforegoing embodiments in FIGS. 3A to 3J, disposed to be visible to the tracker may comprise attaching tracking pole 11, 11′ to the trackable mount and attaching tracking marker 12, 12′ to tracking pole 11, 11′. Confirming that the model exterior shape allows the trackable mount to be stably mountable at the location may comprise confirming that the model exterior shape allows the trackable mount to be reproducibly mountable at the location. Such confirmations are achieved by use of standard 3D visualization or simulation software to model whether such attachments and lights of sight are possible given the boundary conditions of the items themselves and the obstacles apparent in scan data. Should such attachments or locations be either physically impossible or obstruct the line of vision of a tracker, then the violation of such boundary conditions would result in a lack of confirmation, possibly requiring design modification either automated or my manual intervention.

System 500 may further comprise database 590 of exterior shapes for the trackable mount and the establishing the model exterior shape of the trackable mount may comprise searching the database 590 for a predetermined exterior shape. Alternatively, system 500 may include software that allows for selection of a model exterior shape as a template for further revisions, either automated modifications for use in certain procedures or with predetermined surgical tools, or manual modifications using a computer aided design type of software program.

By way of example, the surgical site may be a dental site, the suitable location may be a suitable anchor tooth proximate the surgical site, and the model exterior shape of the trackable mount may be a mathematically describable three-dimensional shape enclosing the anchor tooth. The shape may be a cube, a cuboid, a prismatoid, a parallelepiped or a cylinder. The second set of instructions may further comprise instructions for removing the three dimensional contours of the anchor tooth from the mathematically describable three-dimensional shape enclosing the anchor tooth. The second set of instructions may further comprise instructions for adding to the model exterior shape for the trackable mount the shape of an attachment to the trackable mount, the attachment being any one or more of a tracking marker, a tracking pole, and a locating hole for the attachment.

Creating a software model may comprise extracting model data 550 from the software model; optionally translating model data 550 to another format compatible with further processing, and saving model data 550 to a digital file, the digital file having a three-dimensional digital file format. Saving the model data to a digital file may comprise saving the digital file to non-transitory computer-readable storage medium 580 readable by a controller, for example computer 210 of FIG. 2.

In a further aspect of the present invention, an embodiment includes a non-transitory computer-readable storage medium encoding a first set of instructions executable by a controller, the first set of instructions comprising instructions for making a trackable mount for mounting proximate a surgical site, the mount trackable by a tracker disposed to obtain image information of the surgical site. The first set of instructions may comprise a second set of instructions for creating a software model of the trackable mount based on scan data of the surgical site, and a third set of instructions for making the trackable mount based on model data derived from the software model. The second set of instructions may comprise instructions for obtaining the scan data, determining a suitable location for the trackable mount from the scan data, and establishing a model exterior shape for the trackable mount compatible with tracking of the trackable mount and with the location of the trackable mount. The exterior shape of the trackable mount may comprise at least one of a tracking pole and a tracking marker disposed to be visible to the tracker. The third set of instructions may comprise instructions for transferring the model data to a manufacturing device.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method for making a trackable mount for assisting with surgery within a surgical site, the mount being trackable by a tracker configured and arranged to obtain image information from the surgical site, the method comprising
creating a software model of the trackable mount based on scan data of the surgical site; and
making the trackable mount based on the software model.

2. The method of claim 1 wherein the step of creating the software model comprises:
obtaining the scan data;
determining a suitable location for the trackable mount from the scan data; and
establishing a model exterior shape for the trackable mount compatible with tracking of the trackable mount and with the location of the trackable mount.

3. The method of claim 2 wherein the establishing step includes establishing the exterior shape of the trackable mount to comprise at least one of a tracking pole, and a tracking marker configured and arranged to be visible to the tracker.

4. The method of claim 2 wherein the step of establishing the model exterior shape of the trackable mount comprises confirming that the model exterior shape allows the trackable mount to be usefully trackable by the tracker; and confirming that the model exterior shape allows the trackable mount to be stably mountable at the location.

5. The method of claim 4 wherein the step of confirming that the model exterior shape allows the trackable mount to be usefully trackable comprises confirming that the model exterior shape is configured for the attaching of a tracking marker disposed to be visible to the tracker.

6. The method of claim 5 wherein the step of confirming that the model exterior shape is configured for the attaching of a tracking marker disposed to be visible to the tracker comprises attaching a tracking pole to the trackable mount; and attaching the tracking marker to the tracking pole.

7. The method of claim 4 wherein the step of confirming that the model exterior shape allows the trackable mount to be stably mountable at the location comprises confirming that the model exterior shape allows the trackable mount to be reproducibly mountable at the location.

8. The method of claim 2 wherein the step of establishing the model exterior shape of the trackable mount comprises searching a database for a predetermined exterior shape.

9. The method of claim 2 wherein the surgical site is a dental site, the suitable location is a suitable anchor tooth proximate the surgical site, and the model exterior shape of the trackable mount is a mathematically describable three-dimensional shape enclosing the anchor tooth.

10. The method of claim 1 wherein the step of creating a software model comprises extracting the model data from the software model; and saving the model data to a digital file, the digital file having a three-dimensional digital file format.

11. The method of claim 1 further comprising providing the software model to a manufacturing device.

12. A system for making a trackable mount for mounting proximate a surgical site, the mount being trackable by a tracker configured and arranged to obtain image information of the surgical site, the system comprising:
a controller comprising at least one processor and at least one memory, the at least one memory including scan data of the surgical site, and software configured, when executed by the at least one processor, to create a software model of a trackable mount based on the scan data; and
a manufacturing device in communication with the controller and configured to manufacture an article according to the software model.

13. The system of claim 12 wherein the software further comprises a first set of executable instructions stored in the at least one memory and executable by the at least one processor, the first set of executable instructions comprising a second set of instructions for creating the software model based on the scan data; and a third set of instructions for extracting the model data from the software model, the model data configured to provide the manufacturing device with manufacturing information relating to the article according to the software model.

14. The system of claim 13 wherein the second set of instructions comprises instructions for obtaining the scan data; instructions for determining a suitable location for the trackable mount from the scan data; and instructions for establishing a model exterior shape for the trackable mount compatible with tracking of the trackable mount and with the location of the trackable mount.

15. The system of claim 14 wherein the exterior shape of the trackable mount comprises at least one of a tracking pole and a tracking marker disposed to be visible to the tracker.

16. The system of claim 14 wherein the instructions for establishing the model exterior shape of the trackable mount comprise instructions for confirming that the model exterior shape allows the trackable mount to be usefully trackable by the tracker; and
instructions for confirming that the model exterior shape allows the trackable mount to be stably mountable at the location.

17. The system of claim 16 wherein the instructions for confirming that the model exterior shape allows the trackable mount to be usefully trackable comprise instructions for confirming that the model exterior shape is configured for the attaching of a tracking marker disposed to be visible to the tracker.

18. The system of claim 14 wherein the at least one memory further comprises a database of exterior shapes for the trackable mount, and wherein the instructions for establishing the model exterior shape of the trackable mount comprise instructions for searching the database for a predetermined exterior shape.

19. The system of claim 14 wherein the second set of instructions further comprises instructions for adding to the model exterior shape for the trackable mount the shape of an attachment to the trackable mount, the attachment being at least one of a tracking marker, a tracking pole, and a locating hole for the attachment.

20. A non-transitory computer-readable storage medium encoding a first set of instructions executable by a controller, the first set of instructions comprising instructions when executed by the controller to operate a method for making a trackable mount for assisting with surgery within a surgical site, the mount being trackable by a tracker configured and arranged to obtain image information from the surgical site, the instructions when executed by the controller creating a software model of the trackable mount based on scan data of the surgical site; and instructions when executed by a manufacturing device making the trackable mount based on the software model.

21. The storage medium of claim 20 wherein the first set of instructions comprises a second set of instructions for creating a software model of the trackable mount based on scan data of the surgical site; and a third set of instructions for making further instructions for a manufacturing device to make the trackable mount based on model data derived from the software model.

22. The storage medium of claim 21 wherein the second set of instructions comprises instructions for obtaining the scan data; instructions for determining a suitable location for the trackable mount from the scan data; and instructions for establishing a model exterior shape for the trackable mount compatible with tracking of the trackable mount and with the location of the trackable mount.

23. The storage medium of claim 22 wherein the exterior shape of the trackable mount comprises at least one of a tracking pole and a tracking marker disposed to be visible to the tracker.

24. The storage medium of claim 21 wherein the third set of instructions comprises instructions for transferring the model data to a manufacturing device.
